(19) United States
(12) Patent Application Publication
(10) Pub. No.: US 2011/0004589 A1
(43) Pub. Date: Jan. 6, 2011

(54) DIAGNOSTICS IN A DISTRIBUTED DIRECTORY SYSTEM

(75) Inventors: Charles Martin Rischar, Chardon, OH (US); Raymond John Staron, Chagrin Falls, OH (US); Subbian Govindaraj, Solon, OH (US); Kenwood H. Hall, Hudson, OH (US); David A. Vasko, Solon, OH (US)

Correspondence Address: ROCKWELL AUTOMATION;for Turocy & Watson LLP, 1201 SOUTH SECOND STREET, E-7F19, MILWAUKEE, WI, 53204, US

(73) Assignee: ROCKWELL AUTOMATION TECHNOLOGIES, INC., Mayfield Heights, OH (US)

(21) Appl. No.: 12/498,075

(22) Filed: Jul. 6, 2009

(51) Int. Cl. G06F 17/30; G05B 13/02

(52) U.S. Cl. 707/713; 700/32; 707/705

(57) ABSTRACT

Providing diagnostic functions for a distributed directory employed in an industrial control environment is described herein. By way of example, status of directory entries can be monitored, updated based on activity within the control environment, and propagated to entities coupled with the environment by way of distributed directory nodes. Directory entries can be validated over time and optionally flagged as valid or deleted if invalid. In some aspects, validation can occur via direct communication with entities coupled to the control environment. Changes to directory entries can be tracked, and can be propagated through the distributed directory. Further, automatic reconfiguration of control entities can be implemented based on the changes, resulting in a dynamic and self-adapting control environment.

### TECHNICAL FIELD

The subject specification relates generally to industrial control systems and in particular to updating information for entities that enter a system at different instances.

### BACKGROUND

Industrial control environments can typically involve complex mechanical, electronic, electromechanical, or robotic machinery that performs various automated functions. Examples of industrial machinery can include industrial motors, pumps, conveyors, escalators, drills, refrigeration systems, and so on, that provide a particular physical output. In addition, industrial environments often utilize one or more control devices to determine when to activate or deactivate such machinery, as well as an appropriate level of activation (e.g., an amount of current to supply a variable input motor). Additionally, the control devices can be associated with logical program code that can determine an appropriate time, degree, manner, etc., to operate such machinery based on various determinable circumstances (e.g., output of another device, reading of an optical sensor, electronic measurement such as current level in a device, movement or number of rotations of a device, and so on).

Different controls can be used to provide protective features in an industrial environment. If a user attempts to make a change upon the industrial environment, then various checks can take place to discover if a user is authorized to make the change, such as requesting the user to enter a username and password. In addition, the user can be provided various tools that can assist in making changes to the industrial environment, including providing a template to be used to make different modifications.

Further to the above, industrial environments often employ distributed communication mechanisms to facilitate centralized control of subsets of the environment. For example, an industrial control device can employ a communications bus to operate a set of machinery communicatively coupled with the communications bus. As another example, a set of industrial control devices coupled with a common communication framework can be scheduled, monitored, updated or manually overridden by a computer (or set of computers) coupled with the communication framework, and so on. Industrial environments often employ directories to manage communications and identify what devices are online at a given time (e.g., communicatively coupled with a common industrial environment). To this end, a directory can be employed to register machinery, controllers, computers, robots, etc., with the industrial environment, maintain a list of communication addresses of registered entities, and so on. Thus, efficient and reliable directories provide significant benefits to industrial environments, reducing down time and maximizing industrial productivity. Accordingly, improving functionality and reliability of communications directories has practical significance for industrial control environments.

### SUMMARY

The following discloses a simplified summary of the specification to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

An industrial control configuration can be a dynamic entity where various modules are added to and subtracted from the configuration. Maintaining inter-device communications in such an environment involves propagating updated device information throughout the control configuration, deleting outdated information and configuring newly added devices. To this and related ends, the subject disclosure provides diagnostic functions for a distributed directory employed in an industrial control environment. Status of directory entries can be monitored, updated based on activity within the control environment, propagated to entities coupled with the environment or shared with other distributed directories in the environment.

According to other aspects of the subject disclosure, directory entries can be validated over time and flagged as valid or deleted if invalid. Furthermore, communication errors within the industrial control environment can be employed to initiate validation, or validation can be implemented periodically. In some aspects, direct communication with entities coupled to the control environment can be conducted to facilitate validation of directory entries. For instance, devices can be queried for status or system health information. Information received in response to a query can be updated to a status database. Furthermore, validating or invalidating a directory entry can also be based on such response.

In one or more additional aspects, changes to industrial control commands, programming, logic flow, or other industrial programming, can be implemented based on changes in the industrial environment. Such changes can be identified, for instance, by monitoring distributed directory entries. Particular changes in the industrial environment can be correlated with predetermined industrial programming or configuration states. Upon detecting a particular change or particular industrial environment state, a program or configuration associated with the change/state is implemented within the industrial control environment.

With one set of aspects, an entity can be updated with programming or configuration states upon engaging with an industrial control configuration. For instance, before an entity disengages from the industrial control configuration, metadata pertaining to an entity-configuration relationship can be saved (e.g., including module addresses, capabilities, and the like). Upon returning to the configuration, a check for information retained from a previous engagement is conducted. If substantial configuration or programming changes are identified, the module is updated with new information or configurations correlated with an existing or recent state of the industrial control configuration.

In other aspects, the configuration can retain an up-to-date schema that is provided to an entity upon engaging the configuration. Based upon content of the schema, metadata employed by the entity can be corrected and the entity can modify operation accordingly. The schema can be provided to the entity automatically as well as supplied in response to a direct request.

The following description and the annexed drawings set forth certain illustrative aspects of the specification. These aspects are indicative, however, of but a few of the various ways in which the principles of the specification can be employed. Other advantages and novel features of the specification will become apparent from the following detailed description of the specification when considered in conjunction with the drawings.

### BRIEF DESCRIPTION OF THE DRAWINGS

FIG. 1 illustrates a block diagram of a sample system that conducts status diagnostics for a distributed directory of an industrial control environment.

FIG. 2 depicts a block diagram of a sample system that determines status of industrial control entities according to aspects of the subject disclosure.

FIG. 3 illustrates a block diagram of an example system that reconfigures a subset of a control environment based on changes to the environment.

FIG. 4 depicts a block diagram of an example system that updates state of entities coupling to an industrial control environment according to further aspects.

FIG. 5 illustrates a block diagram of a sample system that monitors a state for entities in a control configuration and validates database entries based thereon.

FIG. 6 depicts a block diagram of an example system that provides a configuration schema to update entities coupling to an industrial environment.

FIG. 7 illustrates a flowchart of an example methodology for performing status diagnostics of an industrial control distributed directory according to some aspects.

FIG. 8 depicts a flowchart of a sample methodology for updating control programming based on identified changes in an industrial environment.

FIG. 9 illustrates a flowchart of an example methodology for tracking changes in a control environment and reconfiguring entities along with disclosed aspects.

FIG. 10 depicts a flowchart of an example methodology for employing a dynamic schema to configure entities based on a current state of a control configuration.

FIG. 11 depicts a flowchart of a sample methodology for distributed directory diagnostics utilizing status data provided by entities in a control configuration.

FIG. 12 illustrates a block diagram of an example computer operable to execute aspects of database diagnostics disclosed herein.

FIG. 13 depicts a block diagram of a sample computing environment that provides remote electronic communication according to aspects of the disclosure.

### DETAILED DESCRIPTION

The claimed subject matter is now described with reference to the drawings. In the following description, for purpose of explanation, numerous specific details are set forth to provide a thorough understanding of the claimed subject matter. It can be evident, however, that the claimed subject matter can be practiced without these specific details. In other instances, well known structures and devices are shown in block diagram form to facilitate describing the claimed subject matter.

As used in this application, the terms “component,” “module,” “system,” “interface,” and the like are generally intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

Furthermore, as used herein, the terms “industrial environment”, “industrial configuration”, “control environment”, “control configuration”, “industrial control arrangement”, “industrial control configuration”, “industrial control environment” or similar, are intended to refer to electrical, mechanical, electromechanical, etc., machinery (e.g., pumps, motors, conveyors, and so on) communicatively or operatively coupled with a set of industrial controllers. The industrial controllers can comprise hardware (e.g., electrical, mechanical, or electromechanical devices), software, firmware, or a suitable combination thereof, for operating the machinery in accordance with programmatic logic. Moreover, the environment, configuration arrangement, etc., can comprise a computer(s), a firewall(s), a network, or like electronic communication, programming or automation control devices or architecture. Further, such terms can include electronic, mechanical or operational switches, valves, safety shut-off devices, or similar manual or automated controls.

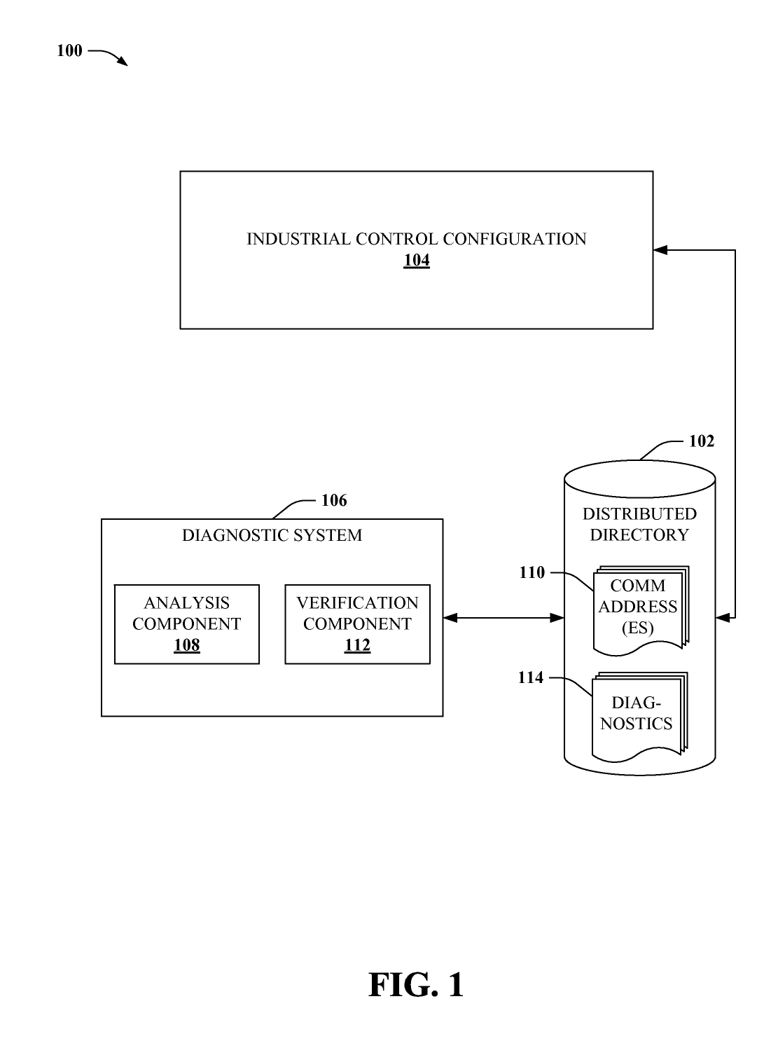

Referring now to the drawings, FIG. 1 illustrates a block diagram of an example system 100 that provides diagnostic functions for an industrial control configuration 104. Industrial control configuration 104 can comprise various industrial entities, such as electrical, mechanical or electromechanical machinery (e.g., robots, switches, pumps, vacuum devices, conveyors, heaters, coolers, motors, and so forth), industrial controllers, computers, electronic communication architectures (e.g., communication bus, computer network, controller network, firewall, router, hub, switches, etc.) or the like. Furthermore, system 100 comprises a distributed directory 102 communicatively coupled with industrial control configuration 104. It should be appreciated that distributed directory 102 can be contained within industrial control configuration 104 or separate from the industrial control configuration 104, or comprise components internal to and external to industrial control configuration 104.

Further to the above, distributed directory can comprise data entries (110, 114) that facilitate communication for entities of industrial control configuration 104. Such communication can be internal communication (e.g., among the entities) or external communication (e.g., among one or more entities and external electronic devices). In some aspects of the subject disclosure, the data entries can comprise communication addresses 110 that distinguish entities on electronic communication architecture (e.g., bus) of industrial control configuration 104. A communication address 110 is correlated to a particular entity and facilitates data exchange with the particular entity. Distributed directory 102 can further comprise diagnostics 114 that portray validity of the communication addresses 1 10. Thus, a valid communication address 110 can be associated with a positive diagnostic 1 14, and an invalid communication address 110 can be associated with a negative diagnostic 114. Accordingly, by referencing distributed directory 102, an entity can obtain a communication address 110 of another such entity, and determine whether the address 110 is valid.

According to particular aspects, system 100 can further comprise a diagnostic system 106 for evaluating communication addresses 110 stored by distributed directory 102. Particularly, diagnostic system 106 can include an analysis component 108 that inspects a subset of communication addresses 110 stored at distributed directory 102. Inspected addresses (110) are provided to a verification component 112 that evaluates such addresses (110) and establishes respective states thereof As an example, analysis component 108 can parse communication addresses 110 of distributed directory 102 and provide a subset of such addresses 110 to verification component 112. Furthermore, verification component 112 can ping, or otherwise electronically signal, such addresses 110 to determine whether an active entity of industrial control configuration 104 is associated with such addresses 110. Verification component 112 can validate an address 110 if the ping is successful, and invalidate the address 110 if the ping is unsuccessful. Results of such an evaluation can be stored in the diagnostic file 114 maintained by distributed directory 102. Furthermore, evaluations can be performed over time and the diagnostics 114 updated based on the evaluations. Accordingly, diagnostic system 106 can help to maintain accuracy and relevance of data stored at distributed directory 102, providing improved reliability for communications involving industrial control configuration 104.

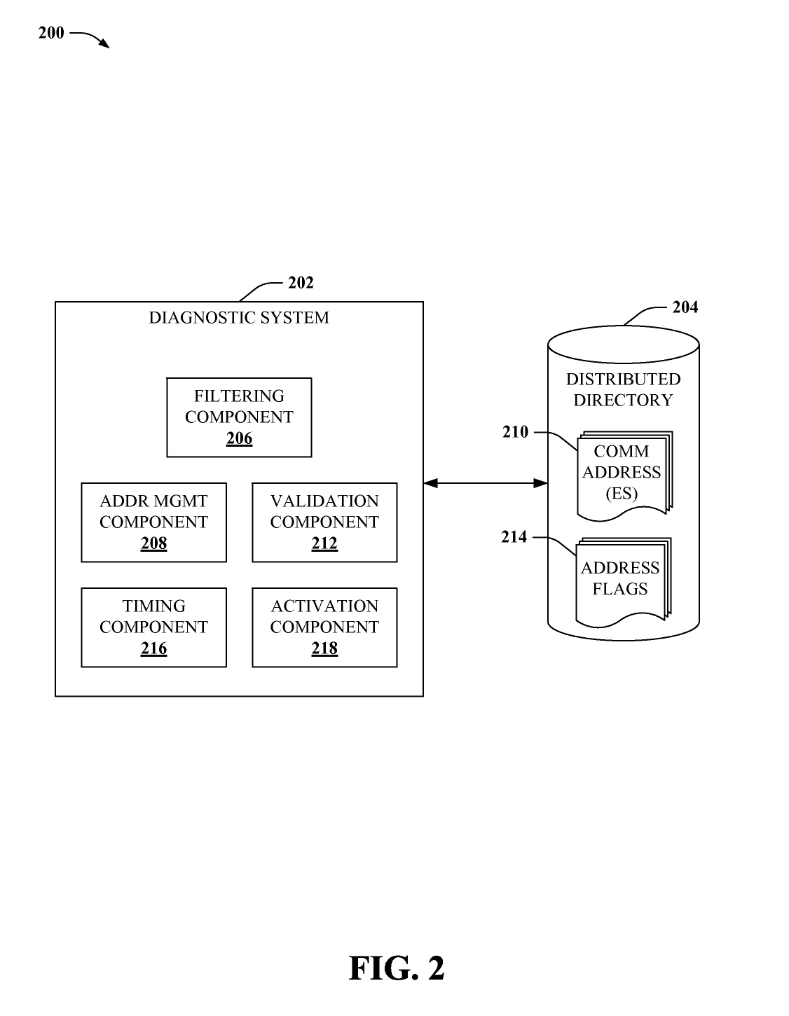

FIG. 2 depicts a block diagram of a sample system 200 that provides diagnostic maintenance in an industrial control environment according to aspects of the subject disclosure. Particularly, system 200 can be employed to evaluate communication status of controllers, hardware, electronics and other entities of the control environment. Communication status can be stored and updated over time to achieve a dynamic representation of the environment.

System 200 comprises a diagnostic system 202 communicatively coupled with a distributed directory 204. Diagnostic system 202 can parse communication addresses 210 maintained by distributed directory to establish validity of such addresses 210. For example, a filtering component 206 can obtain search criteria (e.g., a set of partial or complete addresses 210, entity names or other distinguishing data) and identify a subset of addresses 210 pertinent to the search criteria. The subset of addresses (210) is evaluated and working addresses (e.g. associated with responsive entities of a control environment) are separated from non-working addresses (e.g., associated with non-responsive entities of the control environment). Identification of working and non-working addresses (210) can be determined from signaling conducted by diagnostic system 202 (e.g., in a substantially similar manner as described for diagnostic system 106 at FIG. 1, supra) or signaling conducted by other entities internal to or external to the control environment.

Filtering component 206 can pass a list comprising non-working addresses (210) of the subset to an address management component 208 that deletes the non-working addresses (210) from distributed directory 204. Alternatively, or in addition, filtering component 206 can pass a list comprising working addresses (210) of the subset to a validation component 212 that flags the working address (210) as valid. Address flags 214 can also be stored at distributed directory 204. In some aspects of the subject disclosure, validation component 212 can time stamp an address flag 214 to indicate when an associated address 210 was most recently determined to be a working address (210). Accordingly, entities employing the distributed directory 204 can obtain addresses 210 determined to be valid at least as of the time of validation(s).

Further to the above, diagnostic system 202 can comprise a timing component 216 that triggers diagnostic system 202 to evaluate addresses 210 maintained by distributed directory 204. Specifically, timing component 216 can initiate periodic or pseudo-periodic evaluation, based on a suitable periodic timing function or other time-based function, respectively. Alternatively, or in addition, diagnostic system 202 can comprise an activation component 218 that triggers evaluation of addresses 210 based on a triggering event. In some aspects, a suitable triggering event can comprise receipt of search criteria for filtering addresses 210 (e.g., from a human-machine interface device—not depicted). In other aspects, the triggering event can comprise receipt of a communication error involving an address 210 maintained by distributed directory 204. It should be appreciated that the foregoing triggering events are examples only; other suitable triggering events known to those of skill in the art of industrial controls or made known to those of skill in the art by way of the context provided herein are contemplated as within the scope of the subject disclosure.

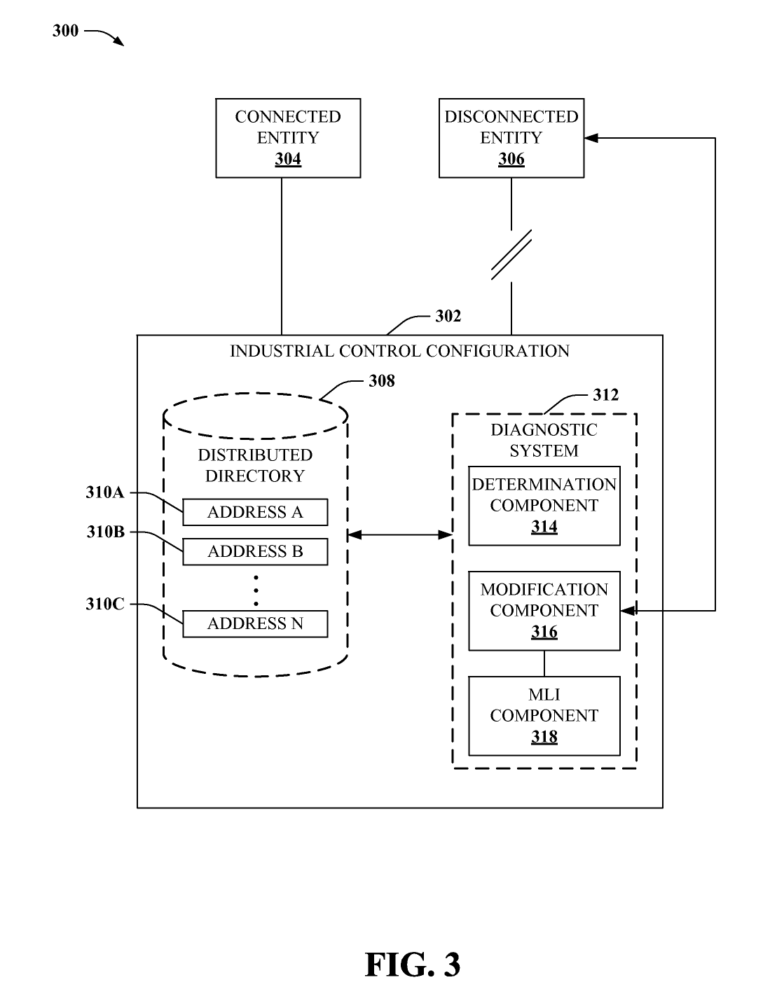

FIG. 3 illustrates a block diagram of an example system 300 that provides updated configuration for an industrial control environment according to aspects of the subject disclosure. System 300 comprises an industrial control configuration 302 and one or more control entities 304, 306. It should be appreciated that industrial control configuration 302 can be dynamic in nature in that control entities (304, 306) engage and disengage with the control configuration 302 throughout operation. For example, a connected entity 304 can be operatively coupled with industrial control configuration 302 and a disconnected entity 306 can be uncoupled with industrial control configuration 302. Entities 304 and 306 can represent a single entity (304, 306) engaged and disengaged with industrial control configuration 302 at different times, or separate entities (304, 306) engaged and disengaged at various times.

Industrial control configuration 302 can employ metadata or other descriptive data (e.g., communication addresses such as address A 310A, address B 310B, and address N 310C, where N is a positive integer) stored in a distributed directory 308 to represent entity relationships, address locations, entity characteristics, or the like. A connected entity 304 can be disassociated with configuration 302 (e.g., become physically removed, lose connectivity, etc.) and re-associate with the configuration 302 at another time. While disassociated, changes in the configuration pertinent to the entity 304 can occur within configuration 302. As an example, in proper operation entity 304 can employ a communication address (e.g., address A 3 10A) to locate another entity (306) of configuration 302. While disassociated, the communication address changes from address A 310A to address B 310B. Thus, when re-association occurs, the metadata is incorrect (e.g., cannot be employed to locate the other entity).

Configuration 300 can employ a diagnostic system 312 to update or correct metadata stored in distributed directory 308. A determination component 314 can identify a relevant change in industrial control configuration 302. The change can include whether metadata (310A, 310B, 310C) stored by distributed directory 308 is modified, or incorrect, for instance. If metadata is incorrect, a modification component 316 can be employed to alter an engagement parameter or rule of an industrial entity (304, 306) associated with the configuration based on an identified change in configuration 302. In some aspects, the alteration can comprise an update to a data link (e.g., a link to information of configuration 302), a change in address information (310A, 310B, 310C) associated with an entity (304, 306), directory metadata (e.g., node location of distributed directory 308), or the like, or a suitable combination thereof. As one particular example, the alteration can include updating retained metadata (310A, 310B, 310C) as well as deleting outdated or incorrect metadata (310A, 310B, 310C). In further aspects, the alteration can be correlated with particular states of the configuration 302. Thus, in such aspects, the alteration depends on the type of change identified by determination component 314.

According to at least one additional aspect of the subject disclosure, modification component 316 operates upon a determination that a change is substantial to operation of industrial control configuration 302 or at least one industrial entity 304, 306. If it is established that a change is not substantial (e.g. by MLI component 318), no update to the configuration 302 or entities 304, 306 is implemented in such aspect(s), to conserve configuration resources or prevent delays associated with reconfiguration. A substantial change (e.g., a change considered important, a change that needs to take place for the entity to operate properly, etc.) can be automatically corrected.

A machine learning and intelligence (MLI) component 318 can be used to facilitate determinations of the system 300. It is to be appreciated that machine learning techniques can be used to practice determinations and inferences disclosed in the subject specification. The MLI component 318 can employ one of numerous methodologies for learning from data and then drawing inferences or making determinations related to identifying changes in configuration or entity state, and determining whether such changes are substantial to communication or operational functions of system 300 (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.). Various methodologies can be employed in accordance with implementing automated aspects described herein. In addition, the MLI component 318 can also include methods for capture of logical relationships such as theorem provers or more heuristic rule-based expert systems. In at least one aspect of the subject disclosure, the MLI component 318 can be represented as an externally pluggable component, in some cases designed by a disparate (third) party.

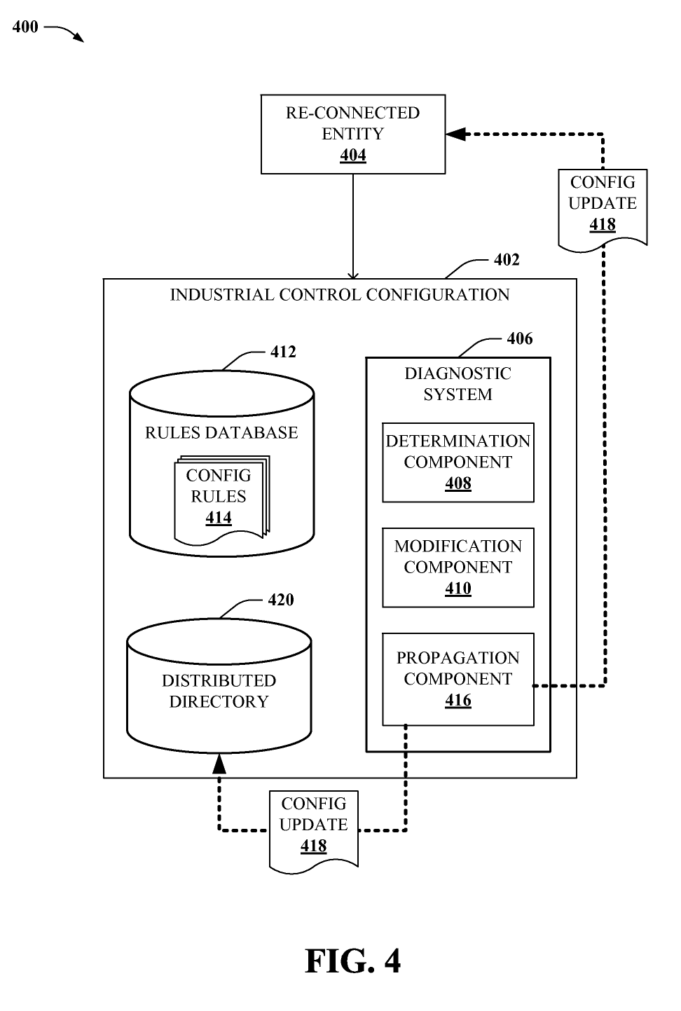

While an alteration can be inferred based upon an identified change, the inference can be drawn instead on, or in conjunction with, substance or nature of the alteration. Thus, for instance, a set of configuration rules (e.g., see FIG. 4 at 414, infra) correlating alterations with configuration changes can be referenced to identify what alteration (e.g., replace outdated information with updated information) is to take place based on the identified change. Based on techniques discussed above, MLI component 318 can further infer an impact to system 300 that results from implementing a particular alteration, and by comparative analysis establish whether a change is substantial enough to incur such impact. Various goals, timelines, procedures, and so on, of configuration 302 or respective entities 304, 306 can be loaded onto MLI component 318 to facilitate such inferences.

As an illustrative example, an entity (304) binds with a distributed directory node (308) with a first engagement to the configuration 302. Upon disconnecting (306) and reconnecting to the configuration 302, the entity (304) might re-enter at a different physical and/or logical location, the node could be removed, or other changes can occur affecting location of the reconnected entity (304) with respect to configuration 302. If such an occurrence is identified by diagnostic system 312, the abovementioned configuration rules can specify that a relationship between the reconnected entity (304) and a node nearest (or, e.g. a default node, or some other specification) such entity (304) should be established. Subsequently, the modification component 316 can create a binding in order to establish the relationship.

It should be appreciated that entities 304, 306 can be part of a group of entities that enters and leaves a configuration at one time or are related and have dynamic functions at different times. In such an arrangement, various benefits can be observed in sharing resources among entities 304, 306. To maintain the shared resources in a dynamic arrangement, alterations established by modification component 316 can be communicated among various entities 304, 306, or results of metadata 310A, 310B, 310C analysis or changes can be distributed among such entities 304, 306. In such aspects, a propagation component (e.g., see FIG. 4 at 416, infra) can be employed to notify at least one other entity of a change or of an alteration, and optionally can further provide a rationale for the alteration.

While FIG. 3 depicts diagnostic system 312 as part of industrial control configuration 302, other implementations can be practiced. For instance, determination component 314 or modification component 316 can be implemented separate from the configuration 302 (e.g. as a stand-alone module or with a third party device). Accordingly, the contemplated scope of system 300 is not limited to the one example layout shown.

FIG. 4 illustrates a block diagram of an example system 400 that provides modified configuration for an industrial control environment. System 400 comprises an industrial control configuration 402 coupled with an industrial entity 404. Specifically, industrial entity 404 can be reconnected with the configuration 402 (e.g., brought back online) after being communicatively or operatively disconnected there from. Upon re-connection, a diagnostic system 406 employs a determination component 408 to identify pertinent changes in operational metadata employed by the configuration 402, which are pertinent to reconnected entity 404. If a suitable change is identified, a modification component 410 can access a rules database 412 to obtain an appropriate action to be taken due to the change. Actions can be specified by a set of configuration rules 414 stored at the rules database 412. In at least one aspect of the subject disclosure, the configuration rules 414 correlate particular actions with particular states of industrial control configuration 402. States of configuration 402 can be based on a number or type of entities (404) coupled with the configuration 402, relationships of such entities (404), operational mode (e.g., active, inactive) of the entities (404), and so on. Furthermore, the rules 414 can correlate particular states with particular actions. Thus, where one state is identified by determination component 408, modification component 410 can extract a predetermined action(s) correlated to the identified state from the rules 414.

If a particular action is selected from the rules 414, a propagation component 416 is employed to convert the action into a configuration update 418 for the reconnected entity 404. In some aspects of the subject disclosure, the configuration update 418 can be applied to other entities of industrial control configuration (not depicted) as well, such as an entity that communicates with, operates in conjunction with, or operates in response to, reconnected entity 404. Configuration update 418 is transmitted to reconnected entity 404 to update operation of such entity 404. Furthermore, the configuration update 418 can be transmitted to a distributed directory 420 that stores state and configuration data pertinent to operation of industrial control configuration 402. In such a manner, a record of configuration updates (418) can be stored at distributed directory 420 and referenced where suitable (e.g., by a human-machine interface device—not depicted).

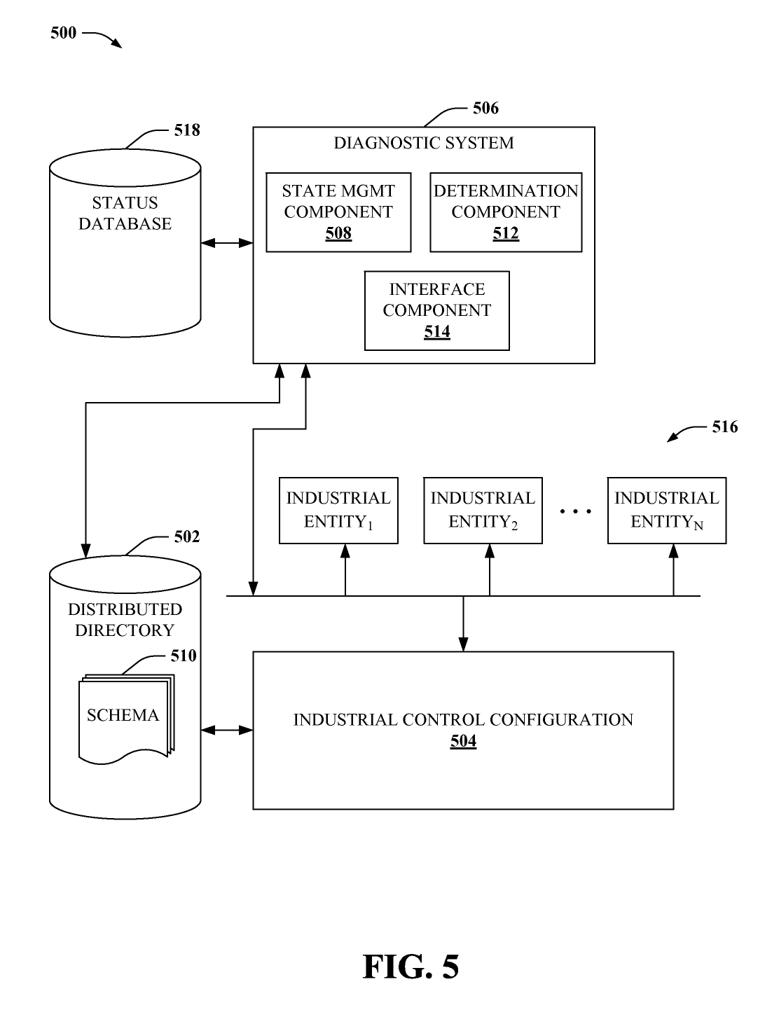

FIG. 5 illustrates a block diagram of a sample system 500 that provides interactive diagnostics in an industrial control environment. System 500 can comprise a distributed directory 502 coupled with an industrial control configuration 504. The industrial control configuration 504 is operatively associated with a set of industrial entities 516, which can include industrial machinery, industrial controllers, computers, computer components, communication network components, or the like, as described herein or known in the art of industrial controls. Distributed directory 502 can be employed to maintain metadata descriptive of communication or operational functions and parameters of control configuration 504 and entities 516. In addition, system 500 can comprise a diagnostic system 506 for analyzing and updating the metadata based on various states of industrial control configuration 504 and industrial entities 516.

Diagnostic system 506 can comprise a state management component 508 that can access a dynamic schema 510 descriptive of interoperability between subsets of industrial control configuration 504 and industrial entities 516. Descriptive data can be extracted by the state management component 508 for use by diagnostic system 506. Particularly, a determination component 512 can employ such data to monitor configuration 504 for changes (e.g., including addition or subtraction of industrial entities 516 coupled with the configuration 504). In one example, determination component 508 can select a set of communication addresses specified by dynamic schema 510 (e.g., based on search criteria), and employ an interface component 514 to directly query entities 516 associated with the selected addresses. Queries can request various data or responses from an industrial entity (516) associated with a selected address, including an explicit or implicit acknowledgment (ACK) response, or more detailed responses that provide state or system health data pertaining to the queried industrial entity (516).

Results of a query are forwarded to determination component 512 and are reflected in the dynamic schema 5 10. For instance, a successful query-response can be updated to the schema, optionally with a time stamp, to indicate validity of entity configurations tested with the query. Likewise, an unsuccessful query-response can be updated to the schema, and metadata descriptive of the configuration 504 and entities 516 can be updated to reflect the failed query-response. In some aspects, the updated schema 510 can be forwarded to one or more entities 516 for re-configuration consistent with the updates.

In addition to updating dynamic schema 510, determination component 512 can also manage state or system health information pertaining to entities 516. Such information, e.g., obtained in response to a query, can be stored in a status database 518. The stored data can be updated over time to reflect changes in entity state/system health. Furthermore, where an entity 516 fails to respond to a query, a default state (e.g., offline) can be updated to a status database entry (518) associated with the queried entity (516). Accordingly, status database 518 can serve as a comparative reference for diagnostic system 506 for determining configuration (504) or entity (516) state, and updating dynamic schema 510 accordingly.

As utilized herein, dynamic schema 510 can employ various data or metadata to describe interoperability or intercommunication between subsets of industrial control configuration 504 (including entities 516). The metadata can reflect or be used to establish rules or parameters for interacting with devices external to configuration 504 as well. In at least some aspects of the subject disclosure, dynamic schema 510 can be provided to industrial entities 516 for self-configuration in accordance with the schema 510. To this end, the schema 510 can include suitable configuration information referenced per entity function, entity name, entity identifier, entity registration (e.g., provided by industrial control configuration when an entity first engages or re-engages to the control configuration), and so forth. Accordingly, respective entities 516 can access the schema 510 and identify data or metadata pertinent to entity self-configuration, by employing a function, identifier, etc., associated with the respective entities 516.

Further to the above, it should be appreciated that, although various components, systems, modules, configurations, etc., are displayed in a particular layout, other layouts are contemplated as part of the subject disclosure. For instance, industrial entities 516, distributed directory 502, diagnostic system 506 or status database 518 can be included within industrial control configuration 504, rather than coupled externally thereto. In such case, system 500 can comprise an integrated industrial network, where configuration 504 comprises only a portion of the whole system/configuration 500.

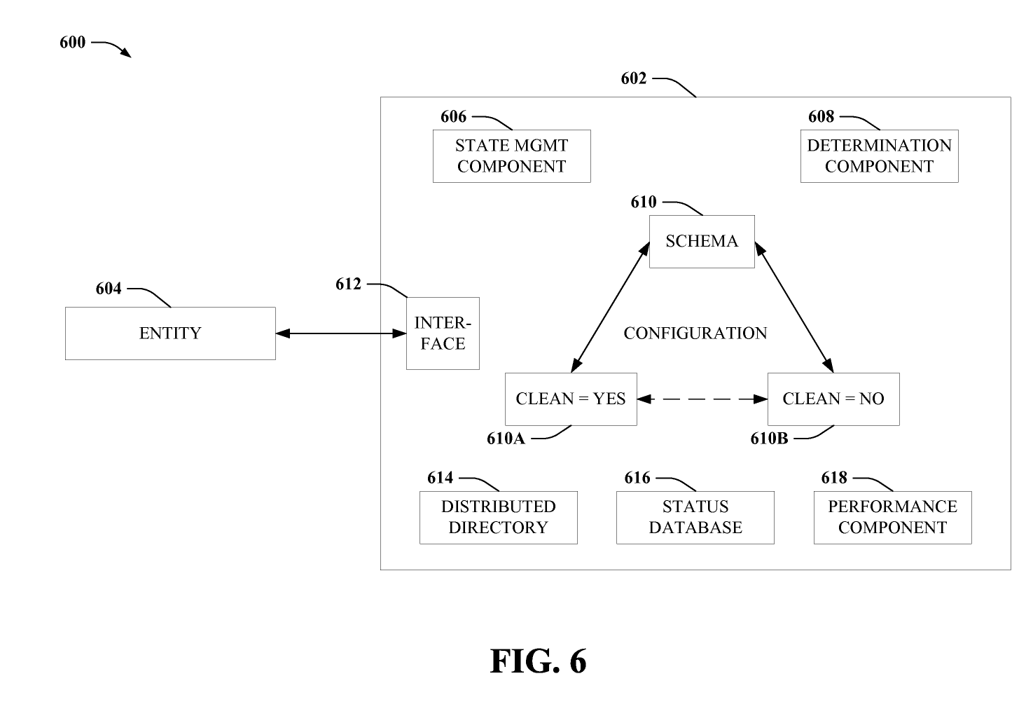

Now referring to FIG. 6, an example system 600 is disclosed for updating out of date entity 604 information (e.g., after a disconnection) from an industrial control configuration 602. The configuration 602 can retain a preferred schema 610 that can be disclosed to the entity 604. The disclosure can occur automatically, through entity request, from a suggestion of a third-party entity (not depicted), etc. As a particular illustrative example, entity 604 comprises an industrial mixing bowl. In such case, the configuration 602 can include a status 610A, 610B of the mixing bowl entity (604), which specifies whether the bowl is clean or dirty. In this example, cleanliness or un-cleanliness is determined by a time-based function, e.g. an elapsed time since last cleaning. However, if the mixing bowl entity 604 is removed from configuration 602, subsequent cleaning data after removal might not be available to configuration 602. Accordingly, the status 610A, 610B provided by the time-based function can no longer reflect the intended clean/unclean status of the mixing bowl entity 604.

To address the foregoing problem, upon joining the configuration 602, the mixing bowl entity 604 can be supplied with schema 610 (e.g., an entire schema, a portion of the schema) and make an appropriate modification (e.g., update cleaning information to configuration 602 or to schema 610). The schema 610 can be general (e.g., provided to any entering entity) or specific (e.g., tailored to the mixing bowl entity 604, tailored to a class of entity such as mixers, etc.). Moreover, metadata can accompany the schema highlighting changes to the configuration 602 occurring after the entity 604 left the configuration 602.

A state management component 606 can be employed to produce and reference the schema 610 (e.g., upon creation of the configuration 602, upon an instruction, etc.). Specifically, the schema 610 can be generated based on observations of configuration 602 made by a determination component 608, in conformity with schema generation rules (not depicted). As one example, the rules can specify that as the configuration 602 changes, schema content should be updated in a predetermined manner (optionally subject to one or more machine learning inferences—see FIG. 3 supra).

Based upon the observations and changes, determination component 608 can establish that configuration 602 requires one or more schema modifications. The determination component 608 can identify an appropriate modification as a function at least of the scope or type of configuration change, and implement the modification to the schema 610. Moreover, the determination component 608 can employ an interface component 612 to extract information from an entity (604) coupled to configuration 602 (e.g., based on a query), and further update schema 610 with such extracted information (e.g., as the entity becomes part of the schema 610). Interface component 612 can also be employed to notify other entities of the update to schema 610. According to one embodiment, the schema 610 can be implemented as part of a distributed directory 614 or status database 616.

In a distributed directory 614, information is propagated to different nodes that are configured to retain matching information. Thus, a device (e.g., configuration 602, entity 604) can place information upon a node, which retains matching information and can also distribute the information among other connected nodes. This can provide additional data and configuration redundancy for an industrial control configuration 602, since the data is not retained at a single point (mitigating data loss). Moreover, such an arrangement can allow for faster communication throughout the configuration 602 based on load balancing at different nodes.

When an entity 604 enters the configuration 602, a variety of bindings can be created, deleted, adjusted, and the like, by components of configuration 602. Specifically, determination component 608 can function to establish bindings that meet one or more configuration goals (e.g., stored at status database 616, or determined through use of MLI techniques based on configuration usage models). Thus, the determination component 608 can function as means for inferring binding management operations among at least two modules.

A binding operation can be implemented by a performance component 618. The performance component 618 can operate as means for performing determined binding management between at least two modules of the industrial control configuration. According to one embodiment, the determination component 608 or performance component 618 can operate at runtime—however, it is to be appreciated that functioning can occur at design time as well as in other instances. The binding management operation can involve creation of a binding, deletion of a binding, modification of a binding, or a combination thereof, as well as related operations.

The aforementioned systems have been described with respect to interaction among several components, modules, configurations, entities or communication interfaces. It should be appreciated that such systems, components, etc. can include those components/components or subcomponents specified therein, some of the specified components or subcomponents, or additional components. For example, a system could include distributed directory 102, diagnostic system 202, analysis component 108, verification component 112, rules database 412 and industrial entities 516, or a different combination of these or other modules. Submodules could also be implemented as modules communicatively coupled to other modules rather than included within parent modules. Additionally, it should be noted that one or more components could be combined into a single component providing aggregate functionality. For instance, modification component 410 can include propagation component 416, or vice versa, to facilitate reconfiguring industrial devices and distributing the reconfiguration by way of a single component. The components can also interact with one or more other components not specifically described herein but known by those of skill in the art.

Furthermore, as will be appreciated, various portions of the disclosed systems above and methods below may include or consist of artificial intelligence or knowledge or rule based components, subcomponents, processes, means, methodologies, or mechanisms (e.g., support vector machines, neural networks, expert systems, Bayesian belief networks, fuzzy logic, data fusion engines, classifiers . . . ). Such components, inter alia, and in addition to that already described herein, can automate certain mechanisms or processes performed thereby to make portions of the systems and methods more adaptive as well as efficient and intelligent.

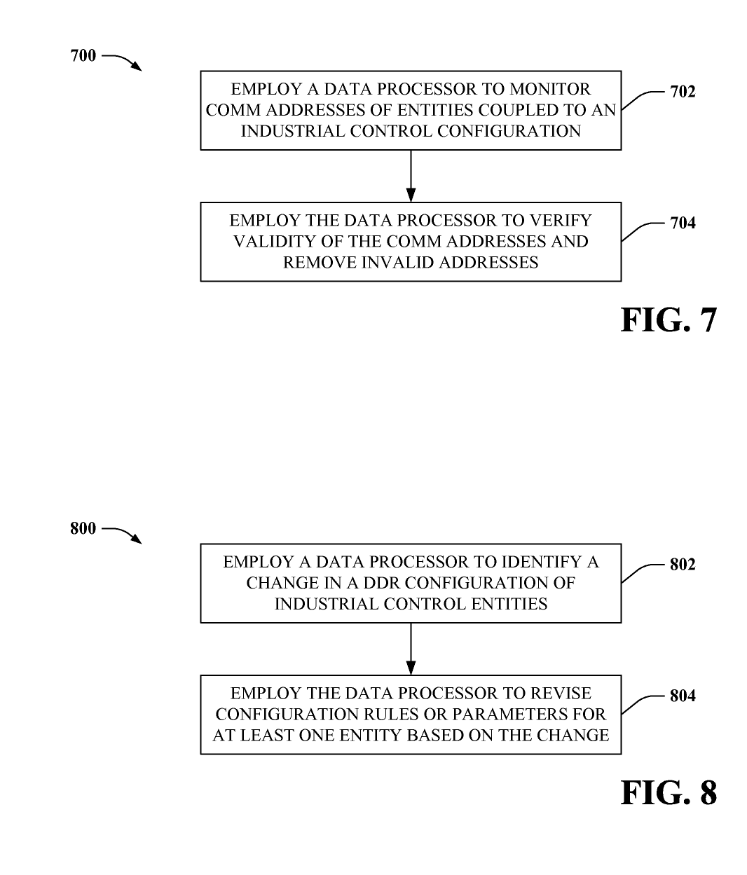

In view of the exemplary systems described supra, methodologies that may be implemented in accordance with the disclosed subject matter will be better appreciated with reference to the flow charts of FIGS. 7-11. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Also, other blocks not depicted herein but known to one of skill in the art, or made known by way of the context provided herein, can be added during implementation of the disclosed methodologies; implementation need not be by the depicted blocks alone. Additionally, it should be further appreciated that the methodologies disclosed hereinafter and throughout this specification are capable of being stored on an article of manufacture to facilitate transporting and transferring such methodologies to computers. The term article of manufacture, as used, is intended to encompass a computer program accessible from any computer-readable device, device in conjunction with a carrier, or storage medium.

FIG. 7 illustrates a flowchart of an example methodology 700 for providing diagnostics in an industrial control environment according to aspects of the subject disclosure. At 702, method 700 can employ a data processor to monitor communication addresses of entities coupled with an industrial control configuration. The entities can be subcomponents of the control configuration (e.g., coupled by a common communication bus) or external components, communicatively coupled by a wired or wireless communication link. Additionally, entities are associated with the communication addresses, which facilitate distinguishing respective entities within the configuration. Accordingly, communication among entities can be conducted via the communication addresses. Furthermore, monitoring the communication addresses can comprise tracking nodes of a distributed directory and analyzing addresses maintained by respective nodes.

At 704, method 700 can employ the data processor to verify validity of the communication addresses and remove invalid addresses from the industrial control configuration. Verification of an address can be implemented by pinging the address for a response, querying the address for status or system health data, analyzing error reports submitted by entities coupled with the control configuration, or the like. Where an anticipated response or analysis is not obtained, an address is invalidated and removed from the industrial control configuration. As described, method 700 can facilitate maintenance of communication addresses, or other metadata associated with industrial control operation. As data descriptive of various control modules or components changes, method 700 can proactively identify changes, analyze the changes and take corrective measures as needed. Accordingly, it is anticipated that method 700 can provide significant efficiency and reliability improvements in industrial control environments.

FIG. 8 illustrates a flowchart of an example methodology 800 according to aspects of the subject disclosure. At 802, method 800 can employ a data processor to identify a change in a distributed directory (DDR) of industrial control entities coupled with an industrial control configuration. The change can involve metadata descriptive of communication or operational logic, and can pertain to entity relationships, location addresses, operational protocols or parameters, programmatic logic, or the like. In at least one aspect, the change in the control configuration can be a result of an entity engaging with or disengaging from the DDR. In such case, method 800 can detect the change due to addition of descriptive metadata in the DDR (e.g., registering engagement of an entity), redundancy of such metadata, or error associated with such metadata (e.g. communication error).

At 804, method 800 can employ the data processor to revise configuration rules or parameters for at least one industrial entity based on the identified change. The revision can comprise deleting superfluous data in the DDR, addition of metadata descriptive of the control configurations, addition of metadata pertaining to a newly engaged entity, and so forth. Furthermore, metadata descriptive of the revision can be propagated within the DDR for use by other entities in performing operations pertinent to the control configuration.

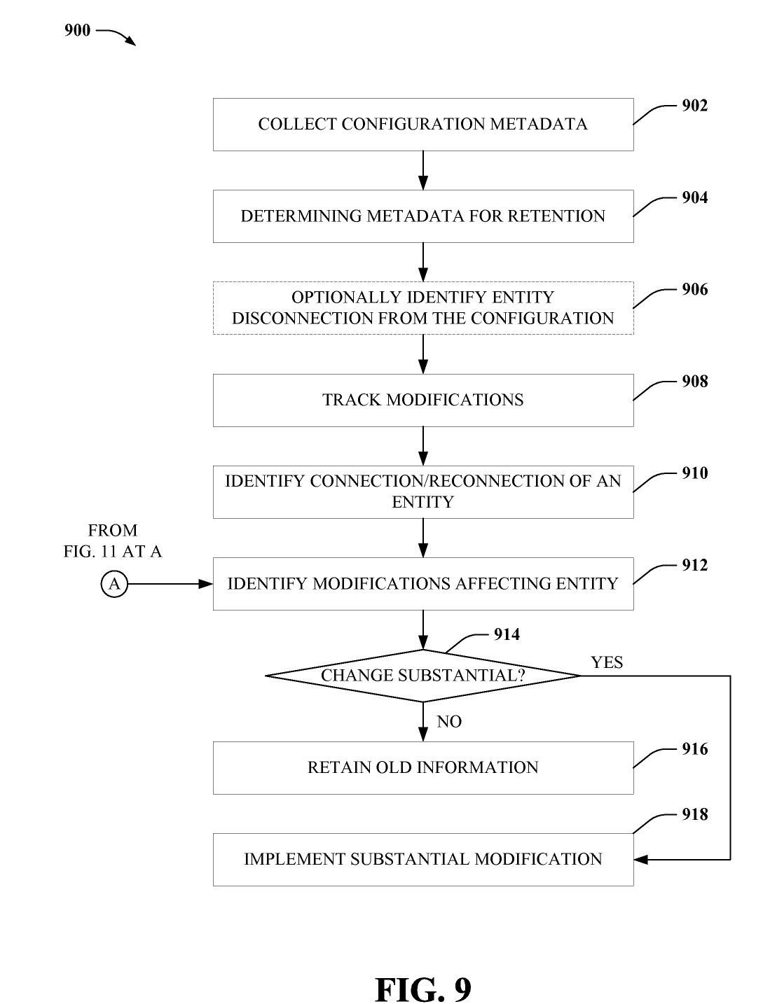

FIG. 9 illustrates a flowchart of a sample methodology 900 for implementing diagnostic management in an industrial control environment. At 902, method 900 can collect configuration metadata pertaining to the environment. The metadata can be descriptive of entities coupled to the environment, as well as programmatic logic governing the entities and environment, as described herein. Furthermore, at 904, method 900 can identify metadata to be retained by the environment for communication or operational logic. At 906, method 900 can optionally identify an entity that is disconnected from the configuration (e.g. by querying communication addresses maintained by a DDR). At 908, method 900 can track modifications to the retained metadata. At 910, method 900 can identify newly connected or reconnected entities engaged to the environment. At 912, method 900 can identify modifications to the metadata pertinent to functions of the connected/reconnected entities. At 914, a decision (or inference) can be made as to whether identified modifications affect the connected/reconnected entities. If no modification affects such entities, method 900 proceeds to 916 where current metadata is retained for the environment. Otherwise, method 900 proceeds to 918 where a modification affecting the entities is implemented. Optionally, the modification can be conditioned on an inference that the modification has at least a threshold impact on the entities, as determined by MLI for instance.

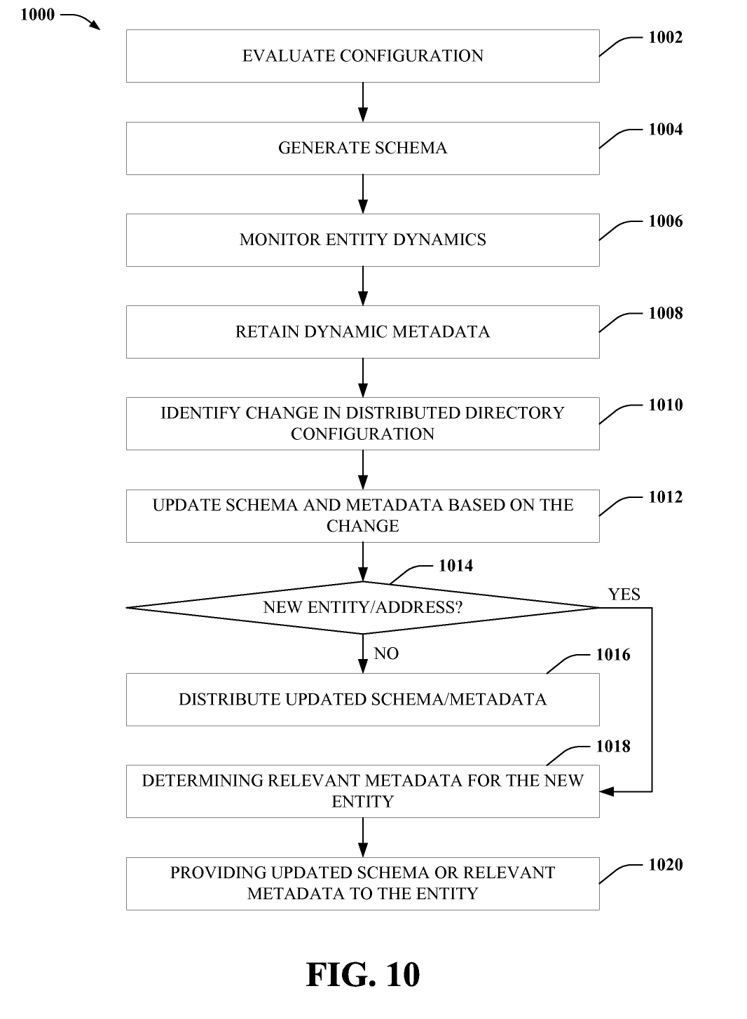

FIG. 10 illustrates a flowchart of a sample methodology 1000 for employing a dynamic schema to configure entities based on a current state of a control environment. At 1002, method 1000 can evaluate existing configurations of the control environment. At 1004, method 1000 can generate a schema comprising metadata descriptive of such configurations. At 1006, method 1000 can monitor entity dynamics and, at 1008, retain metadata for the schema pertinent to such dynamics. At 1010, method 1000 can identify a change in a DDR configuration associated with the environment. At 1012, method 1000 can update the schema and metadata to reflect the change. At 1014, a determination is made as to whether the change involves addition of a new communication address. If a new address is not detected, method 1000 can proceed to 1016 where the updated schema is distributed throughout the DDR. Otherwise, method 1000 proceeds to 1018 where metadata relevant to functionality of an entity correlated with the new address is identified. At 1020, method 1000 can provide the updated schema or relevant metadata to the correlated entity.

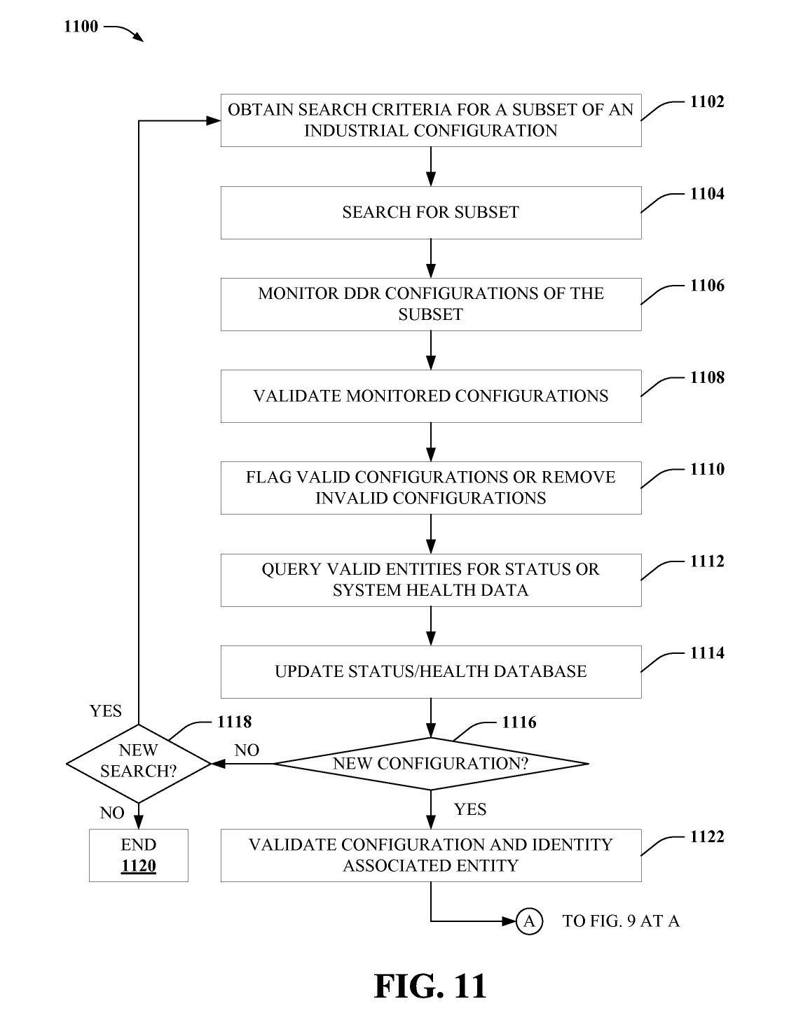

FIG. 11 depicts a flowchart of a sample methodology 1100 providing distributed directory diagnostics utilizing status data provided by entities in a control configuration. At 1102, method 1100 can obtain search criteria for a subset of an industrial control configuration. At 1104, method 1100 can search for and obtain industrial entities pertaining to the search criteria and compile a list of the pertinent entities. At 1106, method 1100 can monitor DDR configurations of the subset of entities. At 1108, method 1100 can monitor and validate or invalidate the DDR configurations. At 1110, method 1100 can flag valid configurations or remove invalid configurations from the DDR. At 1112, method 1100 can query valid entities for status or system health data. At 1114, method 1100 can update status/system health information to a status database associated with the control configuration. At 1116, method 1100 can determine whether any new configurations or changes to existing configurations exist within the DDR. If not, method 1100 proceeds to 1118 where a determination is made as to whether new search criteria are received; if not method 1100 ends at 1120, and otherwise proceeds back to reference number 1102.

If, at reference number 1116, method 1100 determines new or changed configurations, method 1100 can proceed to 1122. At 1122, method 1100 can validate the new/changed configurations and identify entities associated there with. Furthermore, method 1100 can proceed to method 900 at 912 (FIG. 9) to modify DDR configurations if the changes/additions are determined to substantially affect the control configuration.

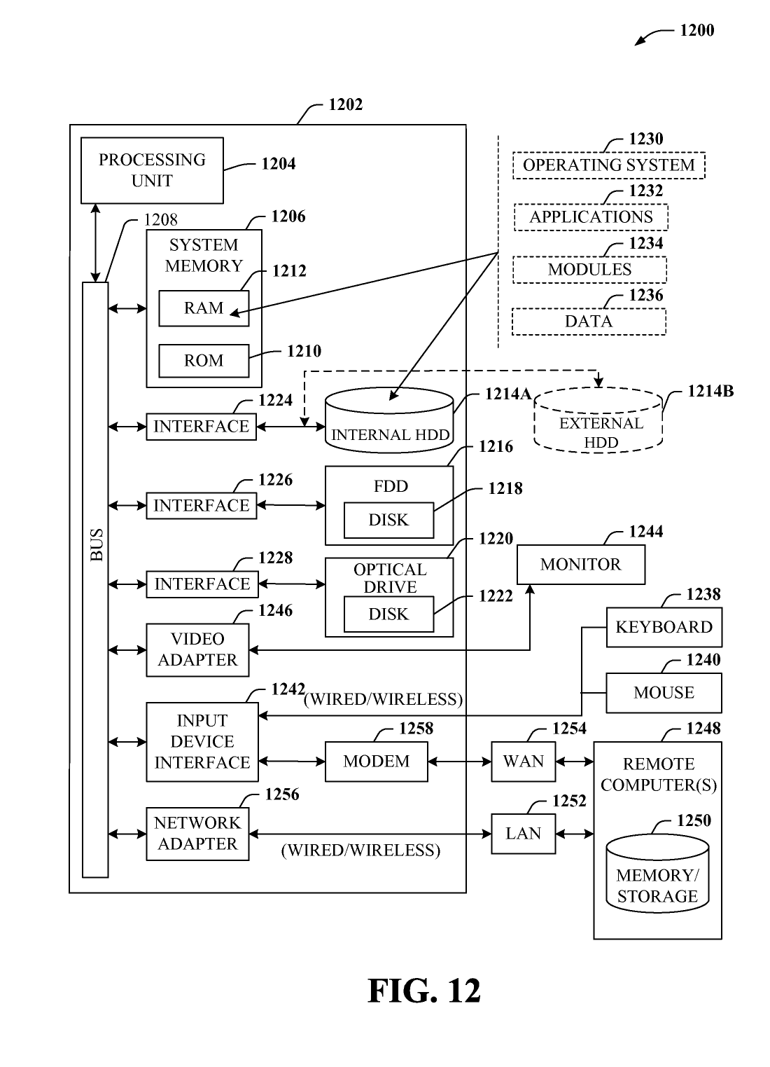

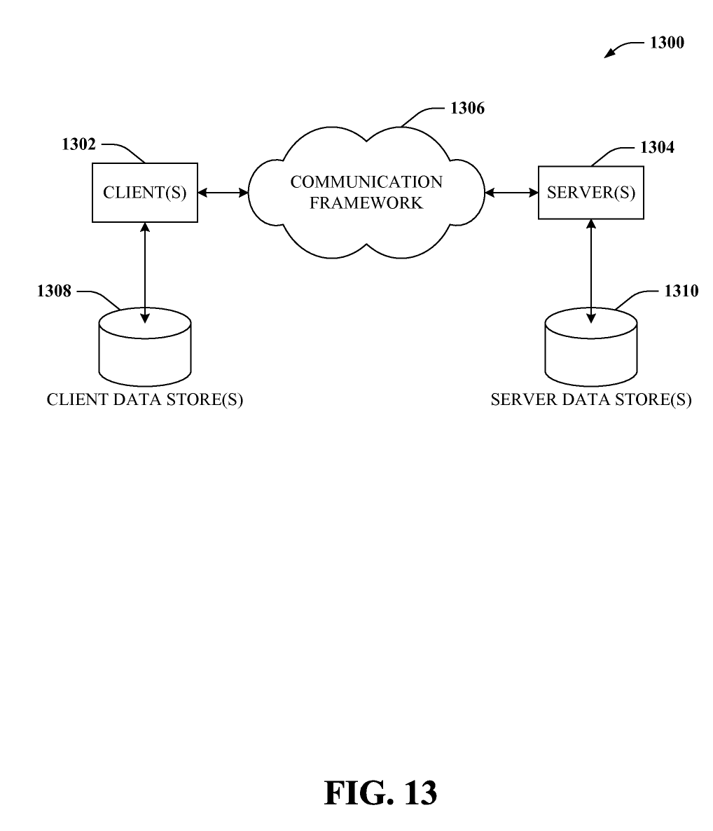

To provide a context for the various aspects of the disclosed subject matter, FIGS. 12 and 13 as well as the following discussion are intended to provide a brief, general description of a suitable environment in which the various aspects of the disclosed subject matter can be implemented. While the subject matter has been described above in the general context of computer-executable instructions of a program that runs on one or more computers or controllers, those skilled in the art will recognize that the subject matter described herein also can be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer or control system configurations, including an industrial controller, or a wide variety of data processors, such as single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects can also be practiced in distributed computing environments where tasks are performed by remote processing devices that are linked through a communications network. However, some, if not all aspects of the claimed subject matter can be practiced on stand-alone computers. In a distributed computing environment, program modules can be located in both local and remote memory storage devices.

Referring now to FIG. 12, there is illustrated a block diagram of a computer operable to execute the disclosed architecture. In order to provide additional context for various aspects of the subject specification, FIG. 12 and the following discussion are intended to provide a brief, general description of a suitable computing environment 1200 in which the various aspects of the specification can be implemented. While the specification has been described above in the general context of computer-executable instructions that can run on one or more computers or industrial controllers, those skilled in the art will recognize that the specification also can be implemented in combination with other program modules and/or as a combination of hardware and software.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embody computer-readable instructions, data structures, program modules or other data in a modulated data signal such as a carrier wave or other transport mechanism, and include any suitable information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of the any of the above should also be included within the scope of computer-readable media.

With reference again to FIG. 12, the example environment 1200 for implementing various aspects of the specification includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors or proprietary specific configured processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes read-only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA), which internal hard disk drive 1214A can also be configured for external use (as indicated in dashed lines by external HDD 1214B) in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the example operating environment, and further, that any such media can contain computer-executable instructions for performing the methods of the specification.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is appreciated that the specification can be implemented with various proprietary or commercially available operating systems or combinations of operating systems.

A user can enter commands and information into the computer 1202 through one or more wired/wireless input devices, e.g. a keyboard 1238 and a pointing device, such as a mouse 1240. Other input devices (not shown) can include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 1394 serial port, a game port, a USB port, an IR interface, etc.

A monitor 1244 or other type of display device is also connected to the system bus 1208 via an interface, such as a video adapter 1246. In addition to the monitor 1244, a computer typically includes other peripheral output devices (not shown), such as speakers, printers, etc.

The computer 1202 can operate in a networked environment using logical connections via wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wired/wireless connectivity to a local area network (LAN) 1252 and/or larger networks, e.g. a wide area network (WAN) 1254. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 is connected to the local network 1252 through a wired and/or wireless communication network interface or adapter 1256. The adapter 1256 can facilitate wired or wireless communication to the LAN 1252, which can also include a wireless access point disposed thereon for communicating with the wireless adapter 1256.

When used in a WAN networking environment, the computer 1202 can include a modem 1258, or is connected to a communications server on the WAN 1254, or has other means for establishing communications over the WAN 1254, such as by way of the Internet. The modem 1258, which can be internal or external and a wired or wireless device, is connected to the system bus 1208 via the input device interface 1242. In a networked environment, program modules depicted relative to the computer 1202, or portions thereof, can be stored in the remote memory/storage device 1250. It will be appreciated that the network connections shown are example and other means of establishing a communications link between the computers can be used.

The computer 1202 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 12BaseT wired Ethernet networks used in many offices.

Referring now to FIG. 13, there is illustrated a schematic block diagram of a computing environment 1300 in accordance with the subject specification. The system 1300 includes one or more client(s) 1302. The client(s) 1302 can be hardware and/or software (e.g., threads, processes, computing devices). The client(s) 1302 can house cookie(s) and/or associated contextual information by employing the specification, for example.

The system 1300 also includes one or more server(s) 1304. The server(s) 1304 can also be hardware and/or software (e.g., threads, processes, computing devices). The servers 1304 can house threads to perform transformations by employing the specification, for example. One possible communication between a client 1302 and a server 1304 can be in the form of a data packet adapted to be transmitted between two or more computer processes. The data packet can include a cookie and/or associated contextual information, for example. The system 1300 includes a communication framework 1306 (e.g., a global communication network such as the Internet) that can be employed to facilitate communications between the client(s) 1302 and the server(s) 1304.

Communications can be facilitated via a wired (including optical fiber) and/or wireless technology. The client(s) 1302 are operatively connected to one or more client data store(s) 1308 that can be employed to store information local to the client(s) 1302 (e.g. cookie(s) and/or associated contextual information). Similarly, the server(s) 1304 are operatively connected to one or more server data store(s) 1310 that can be employed to store information local to the servers 1304.

The aforementioned systems have been described with respect to interaction among several components. It should be appreciated that such systems and components can include those components or subcomponents specified therein, some of the specified components or subcomponents, and/or additional components. Subcomponents can also be implemented as components communicatively coupled to other components rather than included within parent components. Additionally, it should be noted that one or more components could be combined into a single component providing aggregate functionality. The components could also interact with one or more other components not specifically described herein but known by those of skill in the art.

As used herein, the terms to “infer” or “inference” refer generally to the process of reasoning about or deducing states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher level events from a set of events and/or data. Such inference results in the construction of new events or actions from a set of observed events and/or stored event data, whether or not the events are correlated in close temporal proximity, and whether the events and data come from one or several event and data sources.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the subject specification. It is, of course, not possible to describe every conceivable combination of components or methodologies for purposes of describing the subject specification, but one of ordinary skill in the art can recognize that many further combinations and permutations of the subject specification are possible. Accordingly, the subject specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system capable of implementation upon an industrial control configuration, comprising:
an analysis component that inspects a subset of communication addresses within a distributed directory that distinguish industrial entities on a communication platform of the industrial control configuration; and
a verification component that evaluates a subset of the communication addresses and establishes a status for each evaluated address.

2. The system of claim 1, further comprising an address management component that deletes a communication address from the distributed directory referring to a non-responsive industrial entity.

3. The system of claim 1, further comprising a validation component that flags an evaluated communication address that refers to a responsive industrial entity.

4. The system of claim 3, wherein the flag includes a time stamp indicating time of inspection.

5. The system of claim 3, wherein the analysis component re-inspects the subset of communication addresses if the system receives notice of an un-flagged address.

6. The system of claim 1, further comprising at least one of:
a timing component that causes periodic inspection of the distributed directory; or
an activation component that triggers inspection of the distributed directory in response to a communication error submitted by an industrial client entity.

7. The system of claim 1, further comprising a filtering component that selects the subset of the communication addresses based on searchable criteria pertinent to the configuration.

8. A system capable of implementation upon an industrial control configuration, comprising:
a determination component that identifies a relevant change in state of entities engaged with the industrial control configuration based on an analysis of data accessible to a distributed directory that is coupled with the industrial control configuration; and
a modification component that alters an engagement parameter or rule of an industrial entity associated with the configuration as a result of the identified change.

9. The system of claim 8, the alteration comprises a modified link, retained address information, or directory metadata or a combination thereof.

10. The system of claim 8, further comprising a propagation component that notifies another industrial entity associated with the configuration of the alteration.

11. The system of claim 8, further comprising a rules database that stores configuration rules each correlated to a different set of industrial entities operatively coupled with the configuration, the modification component implements a configuration rule suited to operating the industrial control configuration with an updated set of industrial entities, when the determination component identifies as part of the relevant change that the control configuration is comprised of the updated set of entities.

12. The system of claim 11, wherein at least one configuration rule comprises protocols for operating the industrial control configuration in a predetermined state in which a subset of the configuration is offline.

13. A system capable of implementation upon an industrial control configuration, comprising:
a state management component that obtains or establishes a dynamic schema describing interoperability between subsets of the industrial control configuration;
a determination component that monitors the configuration for changes in state of respective subsets and updates the dynamic schema according to identified changes; and
an interface component that queries one or more entities coupled with the configuration for status information in a manner specified by the schema.

14. The system of claim 13, wherein the determination component identifies a communication address correlated to a non-responsive industrial entity and the interface component employs the identified communication address to query non-responsive entity.

15. The system of claim 13, wherein the interface component queries the one or more entities for status information at least one of:
periodically; or
in response to receiving data indicative of an invalid communication address.

16. The system of claim 13, the determination component updates the dynamic schema to include entities registering onto the industrial control configuration and remove entities that terminate registration or that do not respond to the query.

17. The system of claim 13, further comprising a status database for storing and maintaining status information provided in response to the query, the status database is accessible by the one or more entities in communication with other entities of the configuration.

18. A method capable of implementation upon an industrial control configuration, comprising:
employing a data processor to execute the following instructions stored on a computer-readable medium:
monitoring connectivity of entities coupled to the industrial control configuration via entity communication addresses maintained by a distributed directory; and
verifying validity of the communication addresses and removing invalid addresses from the distributed directory.

19. The method of claim 18, further comprising selecting a subset of the addresses for verification based on search criteria input to the data processor.

20. The method of claim 18, further comprising maintaining a dynamic map representing connectivity of the industrial control configuration and updating the dynamic map at least one of:
periodically;
upon a change in the communication addresses maintained by the distributed directory; or
upon submission of a communication error by a configuration entity.

21. The method of claim 18, further comprising querying one or more entities actively coupled with the configuration for status information or system health data.

22. A method capable of implementation upon an industrial control configuration, comprising:
employing a data processor to execute the following instructions stored on a computer-readable medium:
identifying a change in a distributed directory configuration descriptive of an arrangement of entities engaged with the industrial control configuration; and
revising configuration rules or parameters for at least one entity of the configuration based on the change.

23. The method of claim 22, further comprising identifying a non-responsive entity in the arrangement based on status information provided by one or more other entities of the configuration.

24. The method of claim 22, further comprising flagging the non-responsive entity as offline and selecting a configuration rule correlated to the offline entity for the revision.

25. A system implemented as part of a distributed directory of an industrial control configuration, comprising the following features stored on a computer-readable medium:
means for qualifying propriety of a binding operation between at least two modules of the industrial control configuration; and
means for implementing the binding operation based on a change in addressing scheme employed for the industrial control configuration.

26. The system of claim 25, further comprising means for identifying changes in the addressing scheme and means for updating the binding operation based on subsequent identified changes.

27. A system implemented as part of a distributed directory of an industrial control configuration, comprising the following features stored on a computer-readable medium:
means for inspecting a subset of communication addresses maintained by distributed directory employed to facilitate communication among distinct entities of the industrial control configuration; and
means for evaluating a subset of the communication addresses and establishing validity of each evaluated address.

28. The system of claim 27, further comprising means for filtering the subset of communication addresses based on search criteria provided by a client entity.

29. The system of claim 27, further comprising means for removing invalid communication addresses from the distributed directory in response to a communication error submitted by an entity coupled with the configuration.

30. A system implemented as part of a distributed directory of an industrial control configuration, comprising the following features stored on a computer-readable medium:
means for obtaining a change in state of an arrangement of entities coupled with the industrial control configuration; and
means for electronic communication with one or more of the entities that obtains status information or system health data from such entities.

31. The system of claim 30, further comprising means for updating a configuration schema of the industrial control configuration based on predetermined changes in the status information or system health of the one or more entities.
